(19) United States
(12) Patent Application Publication
(10) Pub. No.: US 2021/0342748 A1
(43) Pub. Date: Nov. 4, 2021

(54) TRAINING ASYMMETRIC KERNELS OF DETERMINANTAL POINT PROCESSES

(71) Applicant: INTERNATIONAL BUSINESS MACHINES CORPORATION, Armonk, NY (US)

(72) Inventors: Kohei Miyaguchi, Tokyo (JP); Takayuki Osogami, Kanagawa-ken (JP)

(21) Appl. No.: 16/864,258

(22) Filed: May 1, 2020

(51) Int. Cl. G06N 20/10; G06N 7/00; G06F 17/16; G06F 7/78; G06Q 30/02; G06Q 30/06

(52) U.S. Cl. CPC G06N 20/10; G06N 7/005; G06Q 30/0631; G06F 7/78; G06Q 30/0202; G06F 17/16

(57) ABSTRACT

Determinantal Point Process-based predictions are provided by training an asymmetric kernel of a Determinantal Point Process (DPP) from a training data set by calculating an inverse matrix of a sum of the asymmetric kernel and a first identity matrix, the calculating using an inverse of a sum of the first identity matrix and a symmetric positive semidefinite matrix, a concatenated matrix made from a first matrix and a second matrix and a second identity matrix, the asymmetric kernel including the symmetric positive semidefinite matrix and a skewed-symmetric matrix, the skewed-symmetric matrix being calculated from the first matrix and the second matrix, to produce a prediction model, and outputting the asymmetric kernel as at least a part of the prediction model to make a prediction.

### BACKGROUND

The present invention relates to training asymmetric kernels of Determinantal Point Processes.

Determinantal Point Processes (DPP) have been used to produce a probability distribution in a prediction model. In a DPP, the probability distribution is represented by using a kernel matrix. Use of an asymmetric kernel matrix can enable a higher quality probability distribution than a symmetric kernel matrix. However, training the asymmetric kernel matrix takes enormous time, such as O(N³) for an N×N kernel matrix (where O is the worst case scenario growth rate function, and N is the input size), and thus takes many computational resources.

### SUMMARY

According to an embodiment of the present invention, a computer-implemented method is provided. The computer-implemented method includes: training an asymmetric kernel of a Determinantal Point Process (DPP) from a training data set by calculating an inverse matrix of a sum of the asymmetric kernel and a first identity matrix, the calculating using (i) an inverse of a sum of the first identity matrix and a symmetric positive semidefinite matrix, (ii) a concatenated matrix made from a first matrix and a second matrix and (iii) a second identity matrix, the asymmetric kernel including the symmetric positive semidefinite matrix and a skewed-symmetric matrix, the skewed-symmetric matrix being calculated from the first matrix and the second matrix, to produce a prediction model, and outputting the asymmetric kernel as at least a part of the prediction model to make a prediction.

The foregoing embodiment can also include an apparatus configured to perform the computer-implemented method, and a computer program product storing instructions embodied on a computer-readable medium or programmable circuitry, that, when executed by a processor or the programmable circuitry, cause the processor or the programmable circuitry to perform the method.

The summary clause does not necessarily describe all features of the embodiments of the present invention. Embodiments of the present invention can also include sub-combinations of the features described above.

### BRIEF DESCRIPTION OF THE DRAWINGS

The following description will provide details of preferred embodiments with reference to the following figures wherein:

FIG. 1 shows a kernel L and a subset matrix L_{A} according to an embodiment of the present invention.

FIG. 2 shows an exemplary configuration of an apparatus 10, according to an embodiment of the present invention.

FIG. 3 shows an operational flow for training asymmetric kernels of Determinantal Point Processes, according to an embodiment of the present invention.

FIG. 4 shows an example of a training data set D according to an embodiment of the present invention.

FIG. 5 shows an exemplary algorithm to perform an operational flow for training asymmetric kernels of Determinantal Point Processes, according to an embodiment of the present invention.

FIG. 6 shows an exemplary hardware configuration of a computer that functions as a system, according to an embodiment of the present invention.

### DETAILED DESCRIPTION

Hereinafter, example embodiments of the present invention will be described. The example embodiments shall not limit the invention according to the claims, and the combinations of the features described in the embodiments are not necessarily essential to the invention.

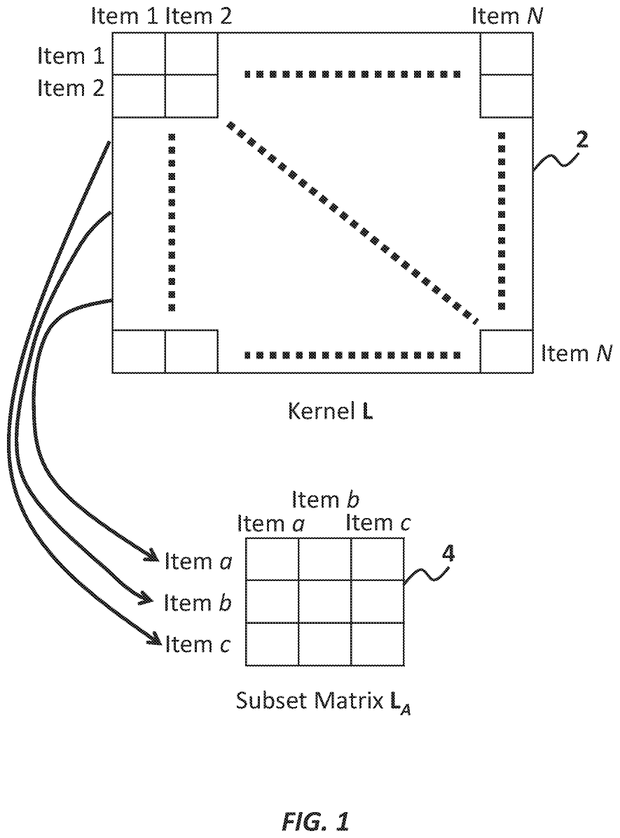

FIG. 1 shows a kernel L 2 and a subset matrix L_{A} 4 according to an embodiment of the present invention. In a machine learning system implementing a DPP, a probability P(A) that subset A is selected can be represented as:

$$P ( A ) = \frac{det ( {L}_{A} )}{det ( I + L )} . \qquad ( 1 )$$

The kernel L 2 is an N×N positive semidefinite matrix, where N can be a number of items. In an embodiment, the kernel L2 is an asymmetric positive semidefinite matrix. The subset matrix L_{A} 4 can represent a subset of the kernel L 2. In an embodiment, the subset matrix L_{A} 4 can be a principal submatrix of the kernel L 2 indexed by A.

In the embodiment of FIG. 1, the kernel L 2 includes N rows and N columns, each corresponding to N items (e.g., item 1, item 2 . . . , item N). The subset matrix L_{A} 4 includes 3 rows and 3 columns, each corresponding to an item a, an item b, and an item c. The items a, b, and c are selected from the items 1 . . . N.

In an embodiment, the probability P(A) represents a probability that items a, b, and c are selected among the items 1 . . . N. By using a DPP, it can be possible to predict which item is newly selected in addition to already selected items.

For example, assuming that a subset matrix L_{A∪{d}} corresponds to items a-d, a subset matrix L_{A∪{e}} corresponds to items a, b, and c and e, and a subset matrix L_{A∪{f}} corresponds to items a, b, and c and f, it will be possible to predict which item is selected among items d, e, and fin addition to the already selected items a, b, and c by comparing P(A∪{d}), P(A∪{e}) and P(A∪{f}), as derived from the subset matrices L_{A∪{d}}, L_{A∪{e}}, and L_{A∪{f}}.

When the kernel L 2 is an asymmetric positive semidefinite matrix, the probability P(A) can represent both positive and negative correlations between items. Meanwhile, when the kernel L 2 is a symmetric positive semidefinite matrix, the probability P(A) can represent only a negative correlation between items.

The positive correlation can mean that if one item is selected, then another item is likely to be selected. The negative correlation can mean that if one item is selected, then another item is unlikely to be selected. The kernel L 2 can be trained by a training data set as explained below.

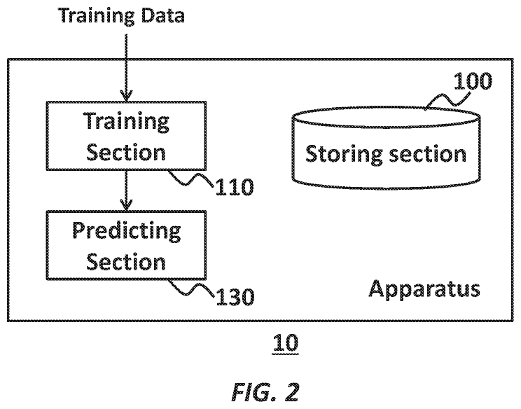

FIG. 2 shows an exemplary configuration of an apparatus 10, according to an embodiment of the present invention. The apparatus 10 can train an asymmetric kernel of a DPP to enable DPP-based prediction with less computational resources and in less time.

The apparatus 10 can include a processor and/or programmable circuitry. The apparatus 10 can further include one or more computer readable mediums collectively including instructions. The instructions can be embodied on the computer readable medium and/or the programmable circuitry. The instructions, when executed by the processor or the programmable circuitry, can cause the processor or the programmable circuitry to operate as a plurality of operating sections. In some embodiments the apparatus 10 can implement a neural network or machine learning model.

Thereby, the apparatus 10 can include a storing section 100, a training section 110 and a predicting section 130.

The storing section 100 stores information used for the processing that the apparatus 10 performs. The storing section 100 can also store a variety of data/instructions used for operations of the apparatus 10.

One or more other elements in the apparatus 10 (e.g., the training section 110 and the predicting section 130) can communicate data directly or via the storing section 100, as necessary.

The storing section 100 can be implemented by a volatile or non-volatile memory of the apparatus 10. In some embodiments, the storing section 100 can store a training data set, matrices and parameters related to an asymmetric kernel of a DPP, and other parameters and data related thereto.

The training section 110 can train an asymmetric kernel of a Determinantal Point Process (DPP) from a training data set. The training section 110 can perform the training by calculating an inverse matrix of a sum of the asymmetric kernel and a first identity matrix.

The asymmetric kernel can include a symmetric positive semidefinite matrix and a skewed-symmetric matrix. The training section 110 can calculate the inverse matrix of the sum of the asymmetric kernel and the first identity matrix by using an inverse of a sum of the first identity matrix and the symmetric positive semidefinite matrix. The training section 110 can perform the training such that a likelihood of the training data set is increased, for example by using a gradient ascent method.

The training section 110 can train the asymmetric kernel to produce a prediction model. In an embodiment, the training section 110 can output the asymmetric kernel as at least a part of the prediction model to the predicting section 130 such that the apparatus 10 itself performs the prediction using the asymmetric kernel. In another embodiment, the training section 110 can output the asymmetric kernel to another apparatus outside the apparatus 10 such as a server computer.

The predicting section 130 can make a prediction based on DPP by using the asymmetric kernel output from the training section 110. In an embodiment, the prediction can include an action prediction that predicts actions (e.g., purchase of certain items) that a common actor (e.g., a customer of items) is likely to perform. The predicting section 130 can make a recommendation based on the prediction. For example, the predicting section 130 can recommend to the customer an item that a customer is likely to purchase.

In an embodiment, the prediction can include predicting a next action of a person, animal, device, etc. in addition to already taken actions. In another embodiment, the prediction can include a prediction relating to a selection of contents, genomes, words, etc. In another embodiment, the prediction can include making a summary of text where words or phrases are selected from an original text.

In an embodiment, the prediction section 130 can be equipped in an apparatus outside the apparatus 10. In the embodiment, training of the asymmetric kernel is performed in an apparatus separate from the apparatus that utilizes the asymmetric kernel.

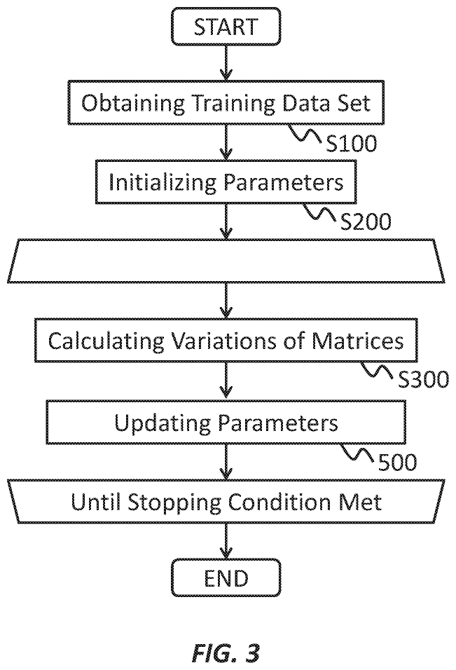

FIG. 3 shows an operational flow for training asymmetric kernels of Determinantal Point Processes, according to an embodiment of the present invention. The present embodiment describes an example in which an apparatus, such as the apparatus 10, performs operations from S100 to S500, as shown in FIG. 3, to train an asymmetric kernel.

At S100, a training section, such as the training section 110 shown in FIG. 2, can obtain a training data set. The training data set can include subsets of actions among a plurality of actions. Each subset of actions can be performed by a common actor among a plurality of actors. Each action among the plurality of actions can be a purchase of an item, and each actor among the plurality of actors can be a customer of items. For example, the subset of actions of the training data can be a subset of items purchased by a customer.

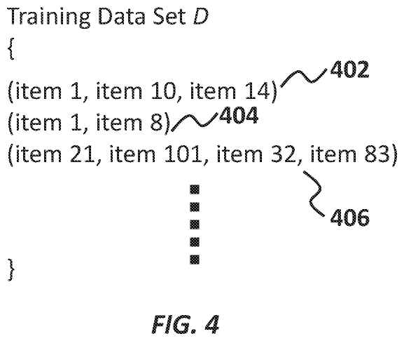

FIG. 4 shows an example of a training data set D according to an embodiment of the present invention. In the embodiment of FIG. 4, the training data set includes a subset 402, a subset 404, a subset 406, and other subsets. Each subset can include one or more items. The subset 402 includes an item 1, an item 10, and an item 14. The subset 404 includes an item 1 and an item 8. The subset 406 includes an item 21, an item 101, an item 32, and an item 83.

In an embodiment, the training data set can include a purchase history including at least one subset of items purchased by each customer. In the embodiment, the training data set D can be generated from a purchase history indicating that (i) one customer (or a group of customers) purchased item 1, item 10, and item 14, (ii) the customer (or the group of customers) purchased item 1 and item 8, and (iii) the customer (or the group of customers) purchased item 21 item 101, item 32, and item 83.

At S200, the training section can initialize a plurality of sub-matrices of the asymmetric kernel L, such as kernel L 2 shown in FIG. 1, to be trained.

In an embodiment, the plurality of sub-matrices includes: a first matrix U (∈∈ [symbol] ^{K×N}), a second matrix V(∈ [symbol] ^{K×N}), a third matrix Λ(∈ [symbol] ^{N×N}), and a fourth matrix F(∈ [symbol] ^{M×N}), where N can be a number of actions (e.g., a number of items), K and M can be arbitrary numbers, such as integers selected from a range of numbers smaller than N. In an embodiment, K can be selected from 1-100. When the number of items in the training data set D is N, the asymmetric kernel L is N×N matrix, the third matrix A is defined as Diag(exp(λ)) where Diag(⋅) denotes the diagonal matrix with given elements, and exp(⋅) is elementwise.

λ is a vector and includes N elements λ₁, λ₂, λ₃, . . . λ_{N}. For example, the third matrix Λ has e^{λ1}, e^{λ2}, e^{λ3}, . . . , e^{λN} as the diagonal elements and 0 as the other elements. The fourth matrix, F, is an M×N matrix, where M is smaller than N. In an embodiment, M can be in the same range as K, such as a number selected from 1-100.

The asymmetric kernel L of DPP can be calculated from the plurality of sub-matrices of the asymmetric kernel L. In an embodiment, the asymmetric kernel L can be represented by a sum of: (i) the third matrix Λ, (ii) a product of the fourth matrix F and a transposed matrix F^{T} of the fourth matrix F, and (iii) a difference of (a) a product of a transposed matrix U^{T} of the first matrix U and the second matrix V and (b) a product of the first matrix U and a transposed matrix V^{T} of the second matrix V. In a specific embodiment, the asymmetric kernel L can be represented by the following formula (2):

L=Λ+F^{T}F+U^{T}V−V^{T}U (2)

The symmetric positive semidefinite matrix of the asymmetric kernel L can be represented by Λ+F^{T}F in the formula (2) and thus can be calculated from the third matrix A and the fourth matrix F. The skewed-symmetric matrix of the asymmetric kernel L can be represented by U^{T}V−V^{T}U and thus can be calculated from the first matrix U and the second matrix V.

At S200, the training section can initialize the first matrix U, and the second matrix V, the third matrix Λ (e.g., λ₁, λ₂, λ₃, . . . , λ_{N}), and the fourth matrix F. In an embodiment, the training section can allocate a value (e.g., 0, 1, or a random number in between) to each element of the first matrix U, each element of the second matrix V, each of the diagonal elements of the third matrix Λ (e.g., λ₁, λ₂, λ₃, . . . , λ_{N}), and each element of the fourth matrix F.

After the initialization of S200, the training section can iterate a loop of operations of S300-S500. During the loop, the training section can update the plurality of sub-matrices (e.g., elements of U, V, Λ, F) derived from the asymmetric kernel L by using the inverse matrix such that a likelihood of the training data set is increased.

At S300, the training section can calculate variations of the plurality of sub-matrices of the asymmetric kernel L. In an embodiment, the training section can calculate variations of the first matrix U, the second matrix V, the third matrix Λ, and the fourth matrix F.

The variation (shown as Δ_{Λ}) of the third matrix Λ can be calculated by the following formula:

$${Δ}_{Λ} = {\sum }_{i = 1}^{n} exp ( λ ) ⊙ diag ( {M}_{i}^{⊤} {L}_{{A}_{i}}^{- 1} {M}_{i} - {( I + L )}^{- 1} ) \qquad ( 3 )$$

where ⊙ denotes the element-wise product, diag(⋅) is the diagonal elements of a given matrix, Mᵢ(∈ [symbol] ^{|A}^{ᵢ}^{|×N}) is the projection operator with respect to Aᵢ such that L_{A}_{ᵢ}=MᵢLMᵢ^{T}, L_{A}_{ᵢ} is the principal submatrix of L indexed by the i-th (i=1 . . . n) subset Aᵢ in the training data set D, and n is a number of subsets in the training data set D.

The training section can calculate Σᵢ₌₁ⁿexp(λ)⊙ diag(Mᵢ^{T}L_{A}_{ᵢ}⁻¹Mᵢ−(I+L)⁻¹) as Δ_{Λ}. Here, the training section calculates an inverse matrix of the sum of the asymmetric kernel and the first identity matrix (I+L) as a part of calculation of the formula (3). According to conventional methods, it takes enormous amounts of time and computational resources to calculate the inverse matrix of a huge matrix such as (I+L).

The training section can calculate the inverse matrix (I+L)⁻¹ by using an inverse of a sum (I+S)⁻¹ of the first identity matrix and a symmetric positive semidefinite matrix S, where S is represented by Λ+F^{T}F meaning a sum of the third matrix Λ and a product of a transposed matrix of the fourth matrix F and the fourth matrix F, because the Woodbury matrix identity equation is applicable to the symmetric positive semidefinite matrix S. The training section can further use a concatenated matrix made from the first matrix U and the second matrix V, and a second identity matrix I_{2K} (2K×2K identity matrix) for the calculation of (I+L)⁻¹ in addition to (I+S)⁻¹.

According to the foregoing embodiments, the training section may not need to directly calculate (I+L)⁻¹. Instead, the training section can calculate the inverse matrix (I+S)⁻¹ within O((K+M)N²) time, which is much shorter than O(N³) time, which is needed for the naïve calculation of (I+L)⁻¹. Therefore, the training section can train the asymmetric kernel L for a larger N than conventional methods. This can increase the variation of recommendations made by a predicting section.

The training section can calculate (I+L)⁻¹ by the following formula:

$${( I + L )}^{- 1} = H - {H [ \begin{matrix}U \\ V\end{matrix} ]}^{⊤} {( {I}_{2 K} + [ \begin{matrix}V \\ - U\end{matrix} ] {H [ \begin{matrix}U \\ V\end{matrix} ]}^{⊤} )}^{- 1} [ \begin{matrix}V \\ - U\end{matrix} ] H \qquad ( 4 )$$

where H is (I+S)⁻¹, and

$$[ \begin{matrix}U \\ V\end{matrix} ] and [ \begin{matrix}V \\ - U\end{matrix} ]$$

is the concatenated matrix made from the first matrix U and the second matrix V. The training section can calculate (I+S)⁻¹ by a known method, such as Woodbury's matrix identity, (I+S)⁻¹=G−GF^{T}(I_{M}+FGF^{T})⁻¹FG, where G=(I+Λ)⁻¹ is a diagonal matrix whose entries are directly computed as

$${G}_{ii} = \frac{1}{1 + {λ}_{i}} ( i = 1 , … , N ) .$$

As shown in the formula (4), by using the concatenated matrix (made from the first matrix U, the second matrix V), and the second identity matrix I_{2K}, the training section can calculate an inverse of a large N×N matrix (I+L) though the calculation of (I+S)⁻¹ and a calculation of an inverse of relatively small 2K×2K matrix. Thereby the training section can calculate (I+L)⁻¹ with less computational resource and time than conventional methods.

The variation (shown as Δ_{S}) of the fourth matrix F can be calculated by the following formula:

$${Δ}_{F} = {\sum }_{i = 1}^{n} F sym ( {M}_{i}^{⊤} {L}_{{A}_{i}}^{- 1} {M}_{i} - {( I + L )}^{- 1} ) \qquad ( 5 )$$

where sym(⋅) is the symmetrization operator given by sym(X)=X+X^{T}, Mᵢ(∈ [symbol] ^{|A}^{ᵢ}^{|×N}) is the projection operator with respect to Aᵢ such that L_{A}_{ᵢ}=MᵢLMᵢ^{%}, L_{A}_{ᵢ} is the principal submatrix of L indexed by the i-th (i=1 . . . n) subset Aᵢ in the training data set D, and n is a number of subsets in the training data set D.

The training section can calculate Σᵢ₌₁ⁿ Fsym(Mᵢ^{T}L_{A}_{ᵢ}⁻¹Mᵢ−(I+L)⁻¹) as Δ_{F}. The training section can calculate Δ_{F} by using (I+S)⁻¹ that has already been calculated for the formula (3) or again calculating (I+L)⁻¹ by using the formula (4).

The variation (shown as Δ_{U}) of the first matrix U and the second matrix V can be calculated by the following formulae:

$$\begin{matrix}{Δ}_{U} = - {\sum }_{i = 1}^{n} Vskew ( {M}_{i}^{⊤} {L}_{{A}_{i}}^{- 1} {M}_{i} - {( I + L )}^{- 1} ) & ( 6 ) \\ {Δ}_{V} = {\sum }_{i = 1}^{n} Uskew ( {M}_{i}^{⊤} {L}_{{A}_{i}}^{- 1} {M}_{i} - {( I + L )}^{- 1} ) & ( 7 )\end{matrix}$$

where skew(⋅) is the skew-symmetrization operator given by skew(X)=X−X^{T}, Mᵢ(∈ [symbol] ^{|A}^{ᵢ}^{|×N}) is the projection operator with respect to Aᵢ such that L_{A}_{ᵢ}=MᵢLMᵢ^{T}, L_{A}_{ᵢ} is the principal submatrix of L indexed by the i-th (i=1 . . . n) subset Aᵢ in the training data set D, and n is a number of subsets in the training data set D.

The training section can calculate −Σᵢ₌₁ⁿ Vskew(Mᵢ^{T}L_{A}_{ᵢ}⁻¹Mᵢ−(I+L)⁻¹) as Δ_{U}. The training section can calculate Σᵢ₌₁ⁿ Uskew(Mᵢ^{T}L_{A}_{ᵢ}⁻¹Mᵢ−(I+L)⁻¹) as Δ_{V}. The training section can calculate Δ_{U} and Δ_{V} by using (I+S)⁻¹ that has already been calculated for the formula (3) or again calculating (I+L)⁻¹ by using the formula (4).

At S500, the training section can update the plurality of sub-matrices of the asymmetric kernel L by using the variations that are calculated at S300. The training section can update the first matrix U, the second matrix V, the third matrix Λ, and the fourth matrix F.

In an embodiment, the training section can update the first matrix U, the second matrix V, the third matrix Λ, and the fourth matrix F by the following formulae:

Λ=Λ+ηΔ_{Λ} (8),

F=F+ηΔ_{F} (9),

U=U+ηΔ_{U} (10),

V=V+ηΔ_{V} (11)

where η is a hyperparameter that is a learning rate. In an embodiment, η is set in a range between 0.001-0.1.

By iterating the loop of S300-S500, the training section can train the parameters of the asymmetric kernel L with a gradient ascent method such that the likelihood of the training data set D is increased.

The training section can iterate the loop until a stopping condition is met. The stopping condition can be a condition usually used in gradient ascent. The stopping condition can be that the training of the asymmetric kernel L has converged, or that a predetermined time has passed. In an embodiment, the training section can end the loop when magnitudes of one or more of Δ_{Λ}, Δ_{F}, Δ_{U}, and Δ_{V} fall below corresponding thresholds.

By performing the operation of FIG. 3, the training section trains the sub-matrices U, V, Λ, F and thereby obtains the asymmetric kernel L calculated from trained sub-matrices U, V, Λ, F. By using the asymmetric kernel L, a predicting section, such as the predicting section 130, can make a DPP-based prediction.

In an embodiment, the predicting section can apply the prediction model to a target subset of actions to make a prediction of whether a target subset of actions will be performed by a common actor. For example, when the training data set includes a purchase history of items purchased by each customer, the prediction model can output a probability that a customer purchases a set of items.

The predicting section can make a recommendation by using the asymmetric kernel L. In an embodiment, for a customer who has already purchased a subset of product α, the predicting section can recommend a product i that maximizes the conditional probability of selecting i given that a has already been selected: P(α ∪ {i}|α) using the formula (1). Thereby, the predicting section can recommend an item that is likely to be purchased by the customer.

The predicting section can find the product i that maximizes P(α ∪ {i}|α) by using the diagonal element of L′=L_{α̅α̅}−L_{α̅α}L_{αα}⁻¹L_{αα̅}, where α̅ is the set of items not in α and L_{xy} denotes the submatrix of L where rows are indexed by x and columns are indexed by y. The i-th diagonal element of L′ is P(α ∪ {i}|α). Therefore, the predicting section can identify the largest diagonal element in L′ as the product i to be recommended.

In the asymmetric kernel L, the symmetric positive semidefinite matrix S can represent a negative correlation between actions and the skewed-symmetric matrix U^{T}V−V^{T}U can represent a positive correlation between actions. In an embodiment, in response to a significance of the skewed-symmetric matrix (e.g., determinant of U^{T}V−V^{T}U) being larger than a threshold significance, the training section can increase the parameter K and again train the asymmetric kernel L. Thereby, the training section can more accurately reflect the negative correlation to the asymmetric kernel L.

Similarly, in response to a significance of the symmetric positive semidefinite matrix S (e.g., determinant of S) being larger than a threshold, the training section can increase the parameter K and again train the asymmetric kernel L. Thereby, the training section can more accurately reflect the positive correlation to the asymmetric kernel L.

In some embodiments, the predicting section can train the asymmetric kernel L in a personalized manner. Thereby, the predicting section can make a personalized recommendation. The predicting section can recommend a target item to each customer by using the probability of each customer to purchase the target set of items, output by the prediction model including the asymmetric kernel. According to embodiments of the present invention, the asymmetric kernel can be trained with less time and resources, and/or the asymmetric kernel can be more finely personalized.

For example, the training section can train an asymmetric kernel L⁽¹⁾ for a person 1, an asymmetric kernel L⁽²⁾ for a person 2, and an asymmetric kernel L⁽³⁾ for a person 3 . . . . In an embodiment, L⁽¹⁾-L⁽³⁾ can represent customers belonging to different clusters (e.g., different age-groups).

According to an embodiment, at least a part of L⁽¹⁾-L⁽³⁾ are shared by persons 1-3. The asymmetric kernels L⁽¹⁾-L⁽³⁾ can be represented by the following formulae:

L⁽¹⁾=Λ+F^{T}F+U₁^{T}V₁−V₁−V₁^{T}U₁ (2-1),

L⁽²⁾=L⁽¹⁾+U₂^{T}V₂−V₂^{T}U₂ (2-2),

L⁽³⁾=L⁽¹⁾+U₃^{T}V₃−V₃^{T}U₃ (2-3).

The training section can train L⁽¹⁾, L⁽²⁾, and L⁽³⁾ by using the flow of FIG. 3. During the flow of FIG. 3, the training section can additionally train U₂, V₂, U₃, V₃ in addition to U₁, V₁, Λ, F. The training section can only need to calculate (I+L⁽¹⁾)⁻¹, (I+L⁽²⁾)⁻¹ and (I+L⁽³⁾)⁻¹. However, once the training section calculates (I+L⁽¹⁾)⁻¹, the training section can efficiently calculate (I+L⁽²⁾)⁻¹ and (I+L⁽³⁾)⁻¹ since the L⁽¹⁾ portion is shared.

In an embodiment, the training section can periodically train the asymmetric kernel. For example, when the training section obtains a new training data set in addition to an already-used training data set, the training section can again train the asymmetric kernel with both training data sets or only the new training data set. It can be difficult to periodically update the asymmetric kernel using conventional methods due to the large amount of computational resources and time required to do so. Meanwhile, according to embodiments of the present invention, the training section can periodically update the asymmetric kernel with a realistic amount of time and resources. Thereby, the training section can improve the quality of the prediction model including the asymmetric kernel.

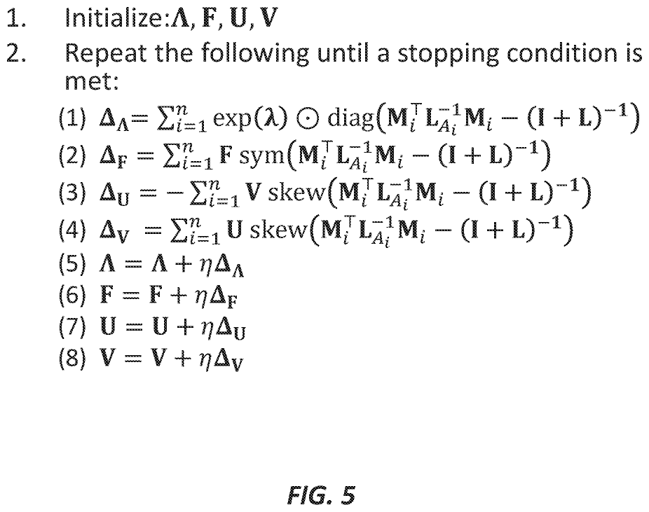

FIG. 5 shows an exemplary algorithm for training asymmetric kernels of Determinantal Point Processes, according to an embodiment of the present invention. In an embodiment, the training section can execute the algorithm shown in FIG. 5 to perform the operations of S200-S500 in FIG. 3.

In the algorithm, line 1 can correspond to the operation of S200. Lines 2(1)-(8) can correspond to the loop of S300-S500. Lines 2(1)-(4) can correspond to the operation of S300. Lines 2(5)-(8) can correspond to the second loop of S500.

Various embodiments of the present invention can be described with reference to flowcharts and block diagrams whose blocks can represent (1) steps of processes in which operations are performed or (2) sections of apparatuses responsible for performing operations. Certain steps and sections can be implemented by dedicated circuitry, programmable circuitry supplied with computer-readable instructions stored on computer-readable media, and/or processors supplied with computer-readable instructions stored on computer-readable media. Dedicated circuitry can include digital and/or analog hardware circuits and can include integrated circuits (IC) and/or discrete circuits. Programmable circuitry can include reconfigurable hardware circuits including logical AND, OR, XOR, NAND, NOR, and other logical operations, flip-flops, registers, memory elements, etc., such as field-programmable gate arrays (FPGA), programmable logic arrays (PLA), etc.

Embodiments of the present invention can be a system, a method, and/or a computer program product at any possible technical detail level of integration. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server.

In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Some embodiments of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which includes one or more executable instructions for implementing the specified logical function(s).

In some embodiments, the functions noted in the blocks can occur out of the order noted in the Figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

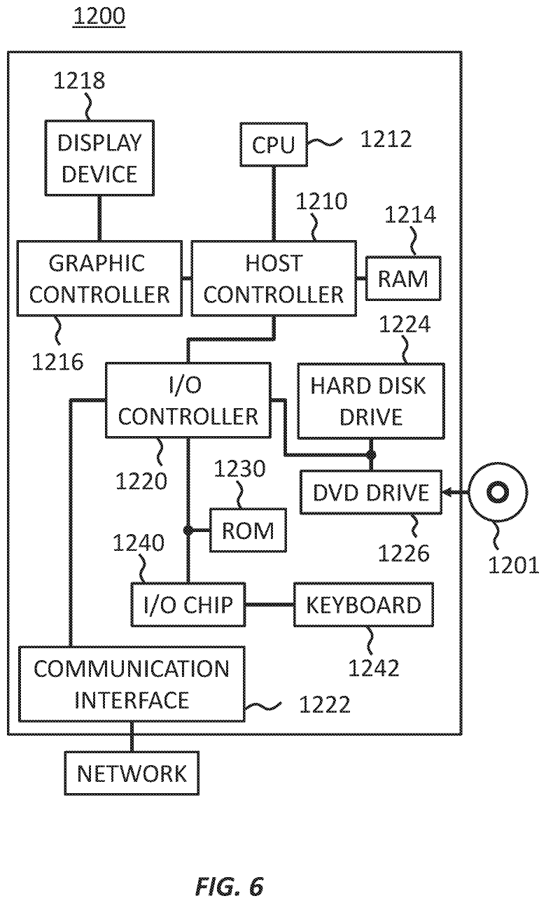

FIG. 6 shows an example of a computer 1200 in which aspects of the present invention can be wholly or partly embodied. A program that is installed in the computer 1200 can cause the computer 1200 to function as or perform operations associated with apparatuses of the embodiments of the present invention or one or more sections thereof, and/or cause the computer 1200 to perform processes of the embodiments of the present invention or steps thereof. Such a program can be executed by the CPU 1212 to cause the computer 1200 to perform certain operations associated with some or all of the blocks of flowcharts and block diagrams described herein.

The computer 1200 according to the present embodiment includes a CPU 1212, a RAM 1214, a graphics controller 1216, and a display device 1218, which are mutually connected by a host controller 1210. The computer 1200 also includes input/output units such as a communication interface 1222, a hard disk drive 1224, a DVD-ROM drive 1226 and an IC card drive, which are connected to the host controller 1210 via an input/output controller 1220. The computer also includes legacy input/output units such as a ROM 1230 and a keyboard 1242, which are connected to the input/output controller 1220 through an input/output chip 1240.

The CPU 1212 operates according to programs stored in the ROM 1230 and the RAM 1214, thereby controlling each unit. The graphics controller 1216 obtains image data generated by the CPU 1212 on a frame buffer or the like provided in the RAM 1214 or in itself, and causes the image data to be displayed on the display device 1218.

The communication interface 1222 communicates with other electronic devices via a network. The hard disk drive 1224 stores programs and data used by the CPU 1212 within the computer 1200. The DVD-ROM drive 1226 reads the programs or the data from the DVD-ROM 1201, and provides the hard disk drive 1224 with the programs or the data via the RAM 1214. The IC card drive reads programs and data from an IC card, and/or writes programs and data into the IC card.

The ROM 1230 stores therein a boot program or the like executed by the computer 1200 at the time of activation, and/or a program depending on the hardware of the computer 1200. The input/output chip 1240 can also connect various input/output units via a parallel port, a serial port, a keyboard port, a mouse port, and the like to the input/output controller 1220.

A program is provided by computer readable media such as the DVD-ROM 1201 or the IC card. The program is read from the computer readable media, installed into the hard disk drive 1224, RAM 1214, or ROM 1230, which are also examples of computer readable media, and executed by the CPU 1212. The information processing described in these programs is read into the computer 1200, resulting in cooperation between a program and the above-mentioned various types of hardware resources. An apparatus or method can be constituted by realizing the operation or processing of information in accordance with the usage of the computer 1200.

For example, when communication is performed between the computer 1200 and an external device, the CPU 1212 can execute a communication program loaded onto the RAM 1214 to instruct communication processing to the communication interface 1222, based on the processing described in the communication program. The communication interface 1222, under control of the CPU 1212, reads transmission data stored on a transmission buffering region provided in a recording medium such as the RAM 1214, the hard disk drive 1224, the DVD-ROM 1201, or the IC card, and transmits the read transmission data to a network or writes reception data received from a network to a reception buffering region or the like provided on the recording medium.

In addition, the CPU 1212 can cause all or a necessary portion of a file or a database to be read into the RAM 1214, the file or the database having been stored in an external recording medium such as the hard disk drive 1224, the DVD-ROM drive 1226 (DVD-ROM 1201), the IC card, etc., and perform various types of processing on the data on the RAM 1214. The CPU 1212 can then write back the processed data to the external recording medium.

Various types of information, such as various types of programs, data, tables, and databases, can be stored in the recording medium to undergo information processing. The CPU 1212 can perform various types of processing on the data read from the RAM 1214, which includes various types of operations, processing of information, condition judging, conditional branch, unconditional branch, search/replace of information, etc., as described throughout this disclosure and designated by an instruction sequence of programs, and writes the result back to the RAM 1214. In addition, the CPU 1212 can search for information in a file, a database, etc., in the recording medium. For example, when a plurality of entries, each having an attribute value of a first attribute associated with an attribute value of a second attribute, are stored in the recording medium, the CPU 1212 can search for an entry matching the condition whose attribute value of the first attribute is designated, from among the plurality of entries, and read the attribute value of the second attribute stored in the entry, thereby obtaining the attribute value of the second attribute associated with the first attribute satisfying the predetermined condition.

The above-explained program or software modules can be stored in the computer readable media on or near the computer 1200. In addition, a recording medium such as a hard disk or a RAM provided in a server system connected to a dedicated communication network or the Internet can be used as the computer readable media, thereby providing the program to the computer 1200 via the network.

While the embodiments of the present invention have been described, the technical scope of the invention is not limited to the above described embodiments. It will be apparent to persons skilled in the art that various alterations and improvements can be added to the above-described embodiments. It should also apparent from the scope of the claims that the embodiments added with such alterations or improvements are within the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

Many of the embodiments of the present invention include artificial intelligence, machine learning, and model training in particular. A model usually starts as a configuration of random values. Such untrained models must be trained before they can be reasonably expected to perform a function with success. Many of the processes described herein are for the purpose of training asymmetric kernels of Determinantal Point Processes. Once trained, an asymmetric kernel can be used for Determinantal Point Processes, and may not require further training. In this way, a trained asymmetric kernel is a product of the process of training an untrained model.

What is claimed is:

1. A computer-implemented method comprising:
training an asymmetric kernel of a Determinantal Point Process (DPP) from a training data set by calculating an inverse matrix of a sum of the asymmetric kernel and a first identity matrix, the calculating using an inverse of a sum of the first identity matrix and a symmetric positive semidefinite matrix, a concatenated matrix made from a first matrix and a second matrix and a second identity matrix, the asymmetric kernel including the symmetric positive semidefinite matrix and a skewed-symmetric matrix, the skewed-symmetric matrix being calculated from the first matrix and the second matrix, to produce a prediction model, and
outputting the asymmetric kernel as at least a part of the prediction model to make a prediction.

2. The method of claim 1, wherein the training data set includes subsets of actions among a plurality of actions, and
the method further comprises applying the prediction model to a target subset of actions to make a prediction of whether a target subset of actions will be performed by a common actor.

3. The method of claim 2, wherein each action among the plurality of actions is a purchase of an item, and each actor among a plurality of actors is a customer, and
the prediction model is trained to output a probability of a customer to purchase a target set of items.

4. The method of claim 1, wherein the asymmetric kernel is calculated as a plurality of sub-matrices, and
training the asymmetric kernel includes updating the plurality of sub-matrices derived from the asymmetric kernel by using the inverse matrix.

5. The method of claim 4, wherein the skewed-symmetric matrix is calculated from a first matrix and a second matrix,
the plurality of sub-matrices includes:
the first matrix,
the second matrix,
a third matrix, and
a fourth matrix, and
the symmetric positive semidefinite matrix is calculated from the third matrix and the fourth matrix.

6. The method of claim 5, wherein the asymmetric kernel can be represented by a sum of:
the third matrix,
a product of the fourth matrix and a transposed matrix of the fourth matrix, and
a difference of a product of a transposed matrix of the first matrix and the second matrix and a product of the first matrix and a transposed matrix of the second matrix.

7. The method of claim 3, further comprising recommending a target item to each customer by using the probability of each customer to purchase the target set of items, output by the prediction model.

8. An apparatus comprising
a processor or a programmable circuitry; and
one or more computer readable mediums collectively including instructions that, when executed by the processor or the programmable circuitry, cause the processor or the programmable circuitry to perform operations including:
training an asymmetric kernel of a Determinantal Point Process (DPP) from a training data set by calculating an inverse matrix of a sum of the asymmetric kernel and a first identity matrix, the calculating using an inverse of a sum of the first identity matrix and a symmetric positive semidefinite matrix, a concatenated matrix made from a first matrix and a second matrix and a second identity matrix, the asymmetric kernel including the symmetric positive semidefinite matrix and a skewed-symmetric matrix, the skewed-symmetric matrix being calculated from the first matrix and the second matrix, to produce a prediction model, and
outputting the asymmetric kernel as at least a part of the prediction model to make a prediction.

9. The apparatus of claim 8, wherein the training data set includes subsets of actions among a plurality of actions, and
the operations further comprise applying the prediction model to a target subset of actions to make a prediction of whether a target subset of actions will be performed by a common actor.

10. The apparatus of claim 9, wherein each action among the plurality of actions is a purchase of an item, and each actor among a plurality of actors is a customer, and
the prediction model is trained to output a probability of the customer to purchase a target set of items.

11. The apparatus of claim 8, wherein the asymmetric kernel is calculated as a plurality of sub-matrices, and
training the asymmetric kernel includes updating the plurality of sub-matrices derived from the asymmetric kernel by using the inverse matrix.

12. The apparatus of claim 11, wherein the skewed-symmetric matrix is calculated from a first matrix and a second matrix,
the plurality of sub-matrices includes:
the first matrix,
the second matrix,
a third matrix, and
a fourth matrix, and
the symmetric positive semidefinite matrix is calculated from the third matrix and the fourth matrix.

13. The apparatus of claim 12, wherein the asymmetric kernel can be represented by a sum of:
the third matrix,
a product of the fourth matrix and a transposed matrix of the fourth matrix, and
a difference of a product of a transposed matrix of the first matrix and the second matrix and a product of the first matrix and a transposed matrix of the second matrix.

14. A computer program product including one or more computer readable storage mediums collectively storing program instructions that are executable by a processor or programmable circuitry to cause the processor or programmable circuitry to perform operations comprising:
training an asymmetric kernel of a Determinantal Point Process (DPP) from a training data set by calculating an inverse matrix of a sum of the asymmetric kernel and a first identity matrix, the calculating using an inverse of a sum of the first identity matrix and a symmetric positive semidefinite matrix, a concatenated matrix made from a first matrix and a second matrix and a second identity matrix, the asymmetric kernel including the symmetric positive semidefinite matrix and a skewed-symmetric matrix, the skewed-symmetric matrix being calculated from the first matrix and the second matrix, to produce a prediction model, and
outputting the asymmetric kernel as at least a part of the prediction model to make a prediction.

15. The computer program product of claim 14, wherein the training data set includes subsets of actions among a plurality of actions, and
the operations further comprise applying the prediction model to a target subset of actions to make a prediction of whether a target subset of actions will be performed by a common actor.

16. The computer program product of claim 15, wherein each action among the plurality of actions is a purchase of an item, and each actor among a plurality of actors is a customer, and
the prediction model is trained to output a probability of a customer to purchase a target set of items.

17. The computer program product of claim 14, wherein the asymmetric kernel is calculated as a plurality of sub-matrices, and
training the asymmetric kernel includes updating the plurality of sub-matrices derived from the asymmetric kernel by using the inverse matrix.

18. The computer program product of claim 17, wherein the skewed-symmetric matrix is calculated from a first matrix and a second matrix,
the plurality of sub-matrices includes:
the first matrix,
the second matrix,
a third matrix, and
a fourth matrix, and
the symmetric positive semidefinite matrix is calculated from the third matrix and the fourth matrix.

19. The computer program product of claim 18, wherein the asymmetric kernel can be represented by a sum of:
the third matrix,
a product of the fourth matrix and a transposed matrix of the fourth matrix, and
a difference of a product of a transposed matrix of the first matrix and the second matrix and a product of the first matrix and a transposed matrix of the second matrix.

20. The computer program product of claim 16, wherein the operations further comprise recommending a target item to each customer by using the probability of each customer to purchase the target set of items, output by the prediction model.
